(19) United States
(12) Patent Application Publication
(10) Pub. No.: US 2008/0008836 A1
(43) Pub. Date: Jan. 10, 2008

(54) Method for extending the useful life of mold type tooling

(76) Inventors: Michael D. Kipp, Provo, UT (US); Michael D. Ridges, American Fork, UT (US); William T. McCarvill, Salt Lake City, UT (US); Kay Mortensen, Payson, UT (US); Dilworth L. Pugh, Mapleton, UT (US); Lynn Wilson, Salt Lake City, UT (US)

Correspondence Address: THORPE NORTH & WESTERN, LLP., 8180 SOUTH 700 EAST, SUITE 350, SANDY, UT, 84070, US

(21) Appl. No.: 11/799,750

(22) Filed: May 1, 2007

Related U.S. Application Data
(60) Provisional application No. 60/796,668, filed on May 1, 2006.

(51) Int. Cl. B05D 3/10; B05D 3/00; B28B 7/36

(52) U.S. Cl. 427/307; 425/96; 427/299

(57) ABSTRACT

A method for enhancing the vacuum integrity and extending the useful life of a mold-type forming tool operable with negative pressure, the method comprising: (a) preparing a surface of the tool to receive a sealing coating thereon; (b) optionally applying a primer material to the surface; (c) obtaining a sealing coating having a formulation comprising a urea and polyurethane composition; (d) applying the sealing coating to the surface, over the primer material, prior to the primer material drying, the primer material interacting with and facilitating a bond of the sealing coating to the surface; and (e) curing the sealing coating to effectuate the bond between the sealing coating and the surface, and to seal the surface.

This application claims priority to U.S. Provisional Patent Application No. 60/796,668, filed May 1, 2006, and entitled, “Method for Extending the Useful Life of Mold Type Tooling,” which is incorporated by reference in its entirety herein.

### FIELD OF THE INVENTION

The present invention relates generally to composite mold type tooling, and more particularly to a method for preparing and applying a sealing or repair coating to a surface of mold type tooling, particularly those designed for use with negative pressure to construct composite products, for the purpose of extending the useful life of such mold type tooling.

### BACKGROUND OF THE INVENTION AND RELATED ART

Developing composite parts that are lightweight, but yet exhibit high strength and superior structural integrity, has been a focus in many industrial fields in recent years. This is attributed to the several advantages such composite parts have over alternative designs. A particular example of one industry taking advantage of composite part development is the aerospace industry. With the increasing prevalence of composite structural materials used in airframes, such as fuselages, wings, etc., the aerospace industry has been at the forefront in the design, development, and fabrication of various composite parts for use in aircraft. Composite parts used in the airframes must meet exacting standards for fit and finish and often incorporate complex curved surfaces. Overall, there has been an increasing need for molds in many industries.

Many manufacturing methodologies have been developed for forming or constructing composite parts. Many of the developed methods require multiple steps or sub-processes to achieve formation of a composite member. One particular sub-process is a vacuum bagging process where multiple layers of composite materials are formed into a desired shape, thus forming a desired product. A typical vacuum bagging process involves placing individual layers of material onto a forming mold or forming tool having a working surface formed in the shape desired. The forming tool must be able to form and maintain an airtight seal about the working surface in order to complete the process.

Traditional vacuum bagging methods initially place a “release layer” onto a mold surface. The release layer functions to reduce the bonding of the composite member with the mold surface and thus enables easy removal. A “prepreg member”, (short for pre-impregnated reinforcement fabrics and/or fibers member), provides the structure and reinforcement for the composite member. The prepreg member is either a dry or wet lay-up component. A dry lay-up is typically a pre-formed structure partially formed prior to being placed onto the release layer. On the other hand, a wet lay-up consists of placing a fabric or fibers onto the release layer, whereupon a liquid epoxy composition is subsequently poured onto the fibers to impregnate the fibers. A partial curing step may be applied to the prepreg member where necessary. Further, a second release layer and a breather/bleeder layer are typically disposed onto the prepreg member, respectively.

The forming tool or forming mold is designed to provide an airtight seal in order to achieve the desired negative pressure. As such, at least one surface of the forming tool, typically the non-working surface, is configured to seal under a negative pressure. To create this seal, one or more surfaces of the forming tool is configured to be impervious to airflow.

Following the composite lay-up, a vacuum bag is placed over the mold encasing the multiple lay-up component parts. The vacuum bag is then placed into an autoclave where the multiple lay-up is processed to form the composite part with application of heat, negative vacuum pressure and external pressure. The vacuum bag and components typically remain in the autoclave until the new composite member is fully cured.

Despite its advantages, there are several problems associated with vacuum bagging processes as used to form a composite part or product. More particularly, there are several problems associated with the various forming tools used in these vacuum bagging processes. In order to form a composite part that is to exhibit the desired properties of composites, it is imperative that the composite part be formed correctly. Thus, any errors or failures in the manufacturing process will likely result in an inadequate composite product.

One area subject to failure is the vacuum bagging process. As this process relies upon a properly sealed forming tool or mold, any failure to create or to maintain a proper seal will result in a leakage of air and the loss of all or a portion of the applied negative pressure. Without a proper airtight seal, the composite product will not be allowed to properly form. As such, once a forming tool becomes defective and loses its vacuum integrity or its ability to form a proper seal, or in other words once the forming tool begins to leak, it is typically considered to have reached the end of its useful life and is discarded, only to be replaced by a new forming tool.

As indicated, it has been found that, under certain conditions, forming tools or molds can begin to deteriorate. This can happen at an accelerated rate if the tool is exposed to extreme conditions. There are several reasons why a forming tool or mold may become defective and lose its vacuum integrity or its ability to seal, and thus begin to leak. The most common reason is that the forming tool, and particularly its sealing surface(s), begins to breakdown or deteriorate over time, thus causing the sealing surface to become porous, or pervious to airflow. Deterioration typically results in premature crazing of the surface coat and the crystallization of resin within the laminate, which causes leaks in the molds. Another reason is that leaks can develop where there are fasteners, such as bolts, that pass through the forming tool, or where there are seams where one part of the forming tool joins another. However, even new forming tools can leak, thus causing them to be inadequate for use. Still another reason is that the tool may become damaged during shipping or handling. In any event, when vacuum integrity is lost, this may result in porosity of the mold, and in any parts formed in the mold. Many composite parts may be produced before the porosity is discovered, leading to the scrapping of these parts.

No matter the reason, when a forming tool loses its vacuum integrity and begins to leak, it must either be repaired or replaced. Typically, however, because of the lack of adequate repair methods, most forming tools that begin to leak are discarded and replaced with new forming tools. This is very expensive, as forming tools can have significant associated costs. Thus, the use and replacement of defective forming tools represents a significant expenditure for those utilizing such a process to produce composite products.

Prior art methods that have been discovered involve applying an epoxy to the forming tool, which epoxy requires long set times and a cure time in an oven or autoclave before the tool can be tested, which makes the forming tool prone to leaks because of the time and effort involved to find and reseal them.

### SUMMARY OF THE INVENTION

In light of the problems and deficiencies inherent in the prior art, the present invention seeks to overcome these by providing a method for preparing and applying a sealing and/or repair coating to a surface of mold type tooling to extend the life cycle of the tooling. The coating may be applied for the purpose of repairing existing tooling currently in use. The coating may also be applied for the purpose of repairing tooling that has already exceeded it's original useful life cycle, thus making the tooling usable once again. Still further, the coating may be applied to new tooling for preventative purposes. In either case, the coating functions, among other things, to extend the useful life cycle of the tooling.

In essence, the method for coating comprises three primary steps, namely preparing a surface of the tooling, which surface may be a working or non-working surface; optionally applying a primer material to facilitate bonding of a sealing coating; and subsequently depositing or applying a suitable sealing coating configured to enhance the vacuum integrity of the tooling, namely to perform a sealing function. However, it is contemplated that the step of preparing the surface may be optional, and thus not necessary in all cases. Indeed, it is foreseeable that a protective coating may be effectively applied to a surface without prior preparation of that surface, although the repair or preventative capabilities of the coating will most likely be somewhat diminished as the bonding between the coating and the surface may not be as good as it otherwise would be had the surface been properly prepared.

In accordance with the invention as embodied and broadly described herein, the present invention features a method for enhancing the vacuum integrity and extending the useful life of a mold-type forming tool operable with negative pressure, the method comprising: (a) preparing a surface of the tool to receive a sealing coating thereon; (b) optionally applying a primer material to the surface; (c) obtaining a sealing coating having a formulation comprising a urea and polyurethane composition; (d) applying the sealing coating to the surface, over the primer material, prior to the primer material drying, the primer material interacting with and facilitating a bond of the sealing coating to the surface; and (e) curing the sealing coating to effectuate the bond between the sealing coating and the surface, and to seal the surface of the forming tool.

The present invention also features a method for enhancing the vacuum integrity and extending the useful life of a mold-type forming tool operable with negative pressure, the method comprising: (a) optionally applying a primer material to a surface of the forming tool; (b) obtaining a sealing coating; (c) applying the sealing coating to the surface, over the primer material, the primer material interacting with and facilitating a bond of the sealing coating to the surface; and (d) curing the sealing coating to effectuate the bond between the sealing coating and the surface of the forming tool, and to seal the surface.

The present invention further features a method for restoring the vacuum integrity of a used forming tool, the method comprising: (a) obtaining a forming tool having exceeded its useful life and having lost at least a portion of its vacuum integrity; (b) optionally applying a primer material to a surface of the forming tool; (c) obtaining a sealing coating; (d) applying the sealing coating to the surface, over the primer material, prior to the primer material drying, the primer material interacting with and facilitating a bond of the sealing coating to the surface; and (e) curing the sealing coating to effectuate the bond of the sealing coating to the surface of the forming tool, thus sealing the surface.

The present invention still further features a mold-type forming tool operable with a negative pressure, wherein the forming tool comprises a useful life determined by its ability to provide and maintain vacuum integrity, the mold-type forming tool comprising: (a) a working surface configured for use in forming a composite part; (b) a non-working surface opposite the working surface; (c) a primer material applied to the non-working surface in anticipation of receiving and bonding with a sealing coating; (d) a sealing coating deposited on the non-working surface over the primer, before the primer is allowed to cure, the sealing coating being configured to enhance the vacuum integrity and prolong the useful life of the forming tool; and (e) a bond effectuated between the primer material, the sealing coating, and the surface of the forming tool, the bond being configured to increase the durability of the sealing coating.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a general flow diagram of a method for enhancing the vacuum integrity of a forming tool, in accordance with one exemplary embodiment of the present invention;

FIG. 2 illustrates a detailed flow diagram of a method for enhancing the vacuum integrity of a forming tool, in accordance with one exemplary embodiment of the present invention;

FIG. 3-A illustrates a partial, cut-away or cross-sectional view of a forming tool having a working surface and a non-working surface, and a primer material deposited onto the non-working surface; and

FIG. 3-B illustrates a partial, cut-away or cross-sectional view of the forming tool of FIG. 3-A, with a sealing coating deposited over the primer material and bonded to the non-working surface.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method for extending or prolonging the useful life of mold-type tooling, otherwise known as forming tools or forming molds, by enhancing the sealing or vacuum integrity of the forming tool. The useful life of a tool may be determined, among other things, by the tool's ability to provide and maintain vacuum integrity as operating with a negative pressure to produce a composite product or part. In one aspect, the present invention method may used to enhance the sealing capabilities, performance and vacuum integrity of a new forming tool or a forming tool currently in use. In another aspect, it may be used to restore tools whose useful life has expired, wherein the restoration process comprises restoring the sealing performance and vacuum integrity of the tool. The method comprises applying a sealing coating to the forming tool, which sealing coating is specifically formulated to provide an airtight seal and to ensure the sealing of the porosity of the forming tool.

The present invention provides several significant advantages, some of which are recited here and throughout the following more detailed description.

For example, the present invention method may be used to seal forming tools at various stages in their life. As indicated, these tools may be new, wherein the method functions to enhance the seal of the tool, or tools that are currently in use or whose useful life has expired, wherein the method functions to either enhance or restore the seal of the tool, or both.

The present invention sealing coating may also function to prevent damage to the forming tool during shipping and handling. The sealing coating applied to the surface of a forming tool will help preserve the surface of the tool, as well as to resist cracking or the formation of other imperfections that contribute to the porosity of the tool.

The sealing coating may be applied and cured within a very short amount of time, thus minimizing the down time of the tool.

The sealing coating may be applied to the non-working surface or side of the tool, thus minimizing or eliminating the post-application procedures needed in order to put the tool in a working condition.

The sealing coating may extend the life of the forming tool at least two to three times beyond its normal life cycle.

Enhancing sealing performance of a forming tool can reduce the need for quality control technicians, thus significantly improving the total preparation time.

Unlike prior related methods, the present invention method contemplates the sealing coating being applied and the desired bond to the forming tool's surface effectuated without the need to vacuum bag the forming tool during the applying or curing processes.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

For purposes of discussion, the terms “mold,” “tool,” “forming tool,” “forming mold,” “mold-type tooling,” as used herein, shall be understood to mean a type of forming tool or mold used to create or form composite parts or products, wherein the forming tool is intended to provide an airtight seal, and that is operable with negative pressure to form the composite member. Examples of forming tools include, but are not limited to, composite forming tools (e.g., graphite, carbon, vectran, aramid, blended, reinforced, etc.), reinforced glass forming tools, metallic forming tools, and/or any combination of these.

The term “sealing coating,” “coating,” “repair coating,” as used herein, shall be understood to mean an applied coating intended to bond (e.g., adhere) with the surface of the forming tool to provide an airtight seal that extends or restores the vacuum integrity of the forming tool. An example of a particular sealing coating is a thermosetting resin comprising urea and urethane components.

The term “vacuum integrity,” as used herein, shall be understood to mean the forming tool's ability to provide an airtight seal capable of sustaining a negative pressure up to a pre-determined amount for a pre-determined period of time. The loss of vacuum integrity means that the forming tool has become sufficiently porous so as to lose its airtight seal to some degree.

The term “resin,” as used herein, shall be understood to mean any resin known in the art suitable for use with the present invention. Resins may include, among others, thermosetting resins, thermoplastic resins, and polymeric resins. It is intended that a resin, as described herein, include all suitable polymers, derivates, solvates and mixtures thereof.

The term “spray,” or similar terminology, as used herein, shall be understood to mean the act of projecting or propagating the motion of a material towards an object. For example, spraying may comprise utilizing a sprayer to project a sealing coating through the air in a mist configuration towards the surface of a tool. Spraying may be effectuated using any method known by those skilled in the art. A spraying method may include an airless, aerosol, robotic or mechanical method.

The term “surface” or “tool surface,” as used herein, shall be understood to mean a surface located on a particular side of a tool. A side of a tool may include various surfaces or surface areas, including, but not limited to, a tool surface, a fastener surface area, a seam or joint surface area, etc. Thus, when indicating a sealing coating is applied to a “surface” of a tool, it is intended that such surface may comprise any one or all of the surfaces or surface areas located on that particular side of the tool being coated.

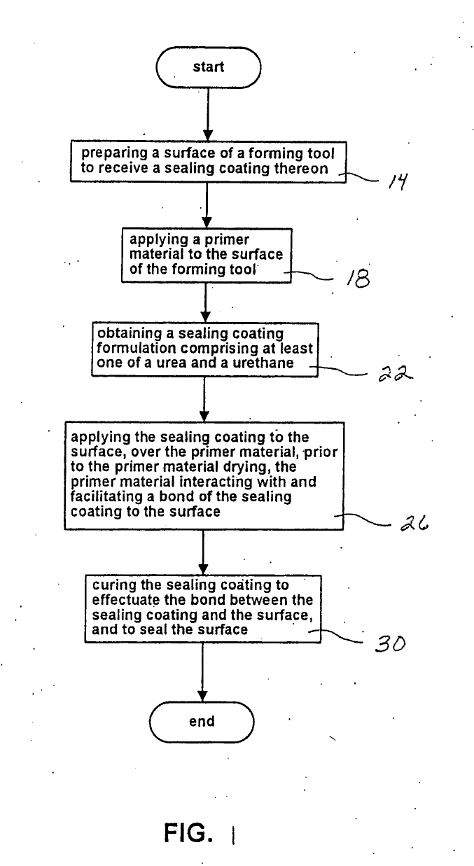

With reference to FIG. 1, illustrated is a flow diagram illustrating, generally, a method of enhancing the vacuum integrity and extending the useful life of a mold-type forming tool (hereinafter, “forming tool”), in accordance with one exemplary embodiment of the present invention. The method comprises step 14, preparing a surface of the forming tool, which may be an optional step; step 18, applying a primer material to the surface of the forming tool, which surface may be the working or non-working surface, and which step may also be optional; step 22, obtaining a sealing coating formulation comprising a resin formulation, such as a urea and urethane combination; step 26, applying the sealing coating to the surface, over the primer material, preferably prior to the primer material drying, which primer material functions to interact with and facilitate a bond of the sealing coating to the surface of the forming tool; and step 30, curing the sealing coating to effectuate the bond between the sealing coating and the surface of the forming tool, and to therefore seal the surface. Each of these steps is described in more detail below.

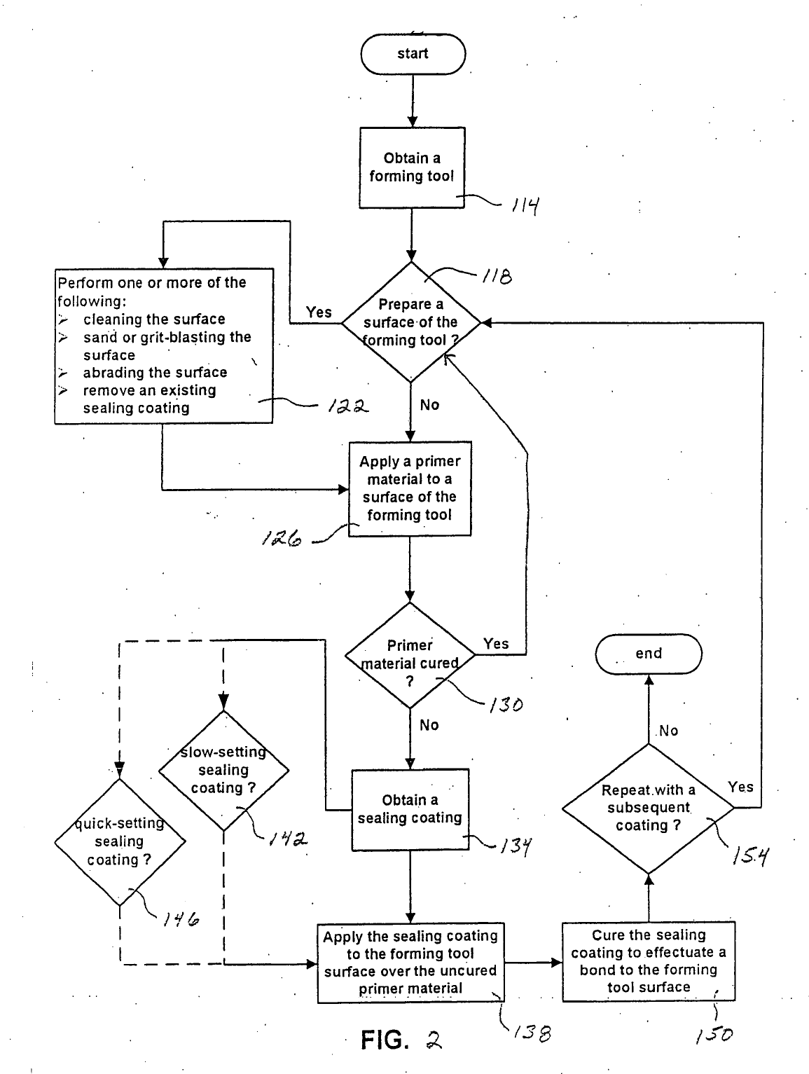

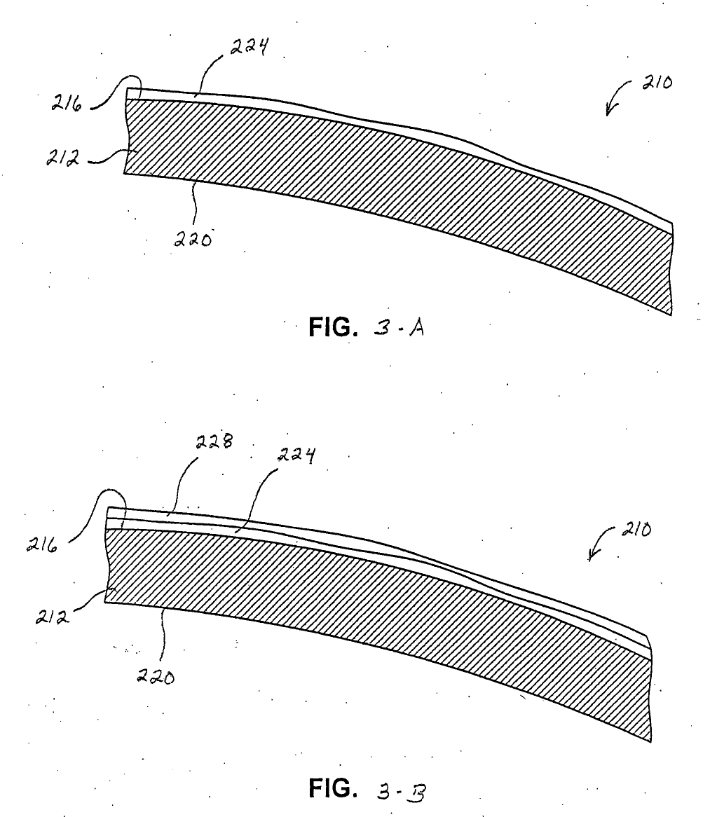

FIG. 2 illustrates a more detailed flow diagram of a method for enhancing the vacuum integrity and extending the useful life of a forming tool, in accordance with one exemplary embodiment of the present invention. As shown, the method comprises step 114, obtaining a forming tool. The forming tool may be configured with a working surface and a non-working surface located opposite the working surface (see FIG. 3). In addition, the forming tool may comprise a plurality of component parts, each of which are coupled or assembled together using any known coupling means (e.g., fasteners, such as bolts, etc.) to construct the forming tool. The forming tool may comprise a pre-fabricated configuration with a substantially flat or contoured working surface, or any combination of these, which working surface functions to dictate or define the shape of the desired composite part to be formed. The working surface may further comprise various corners, curves and/or surface protrusions.

The forming tool may comprise any material makeup known in the art. For example, the forming tool may be comprised of a composite material (e.g., graphite, carbon vectran, airamid, blended, reinforced, etc.), a ceramic material, a reinforced glass material, a metallic material, or any combination of these. The most common type of forming tool is a metallic forming tool, or at least a forming tool having a metallic surface. In addition, the forming tool may be configured to comprise a porous or non-porous configuration. Those skilled in the art will recognize the several different types of forming tools, and their makeup, operable to receive a sealing coating in accordance with the teachings herein.

The forming tool may contain undesirable cracks, pores or grooves that may weaken or otherwise render the forming tool unusable. In other words, such cracks, pores or grooves may further defeat the vacuum integrity of the forming tool. These cracks, pores or grooves may be the result of many different things, such as the forming tool being damaged during shipping and/or handling, prolonged use, normal wear and tear, exposure to high temperatures for extended periods of time, or any others recognized by those skilled in the art. Once such undesirable cracks, pores or grooves appear, the forming tool will begin to lose its sealing capabilities, thus requiring repair or replacement.

As indicated, the present invention contemplates enhancing the vacuum integrity and extending the useful life of various types of forming tools. It is also contemplated that the present invention method may be applied to various types of forming tools that exist in different conditions. Indeed, the ability of the present invention method to extend the useful life of a forming tool may have different meanings and/or applications depending upon the type and condition of the forming tool. For example, in one aspect, the present invention method may be applied to enhance the vacuum integrity and extend the useful life of new forming tools. Although new, a sealing coating applied in accordance with the present invention will function to preserve the surface(s) of the forming tool, as well as to prevent or resist cracks, fissures, etc. that would otherwise defeat the vacuum integrity of the tool at a much earlier stage in the forming tool's life. In this capacity, the present invention method and resulting sealing coating functions as a preventative measure.

In another aspect, the present invention method may be applied to enhance the vacuum integrity and extend the useful life of forming tools currently in use. It is well known that forming tools begin to breakdown and lose their ability to form a good vacuum seal over time and with repeated use as a result of the harsh and extreme conditions these forming tools are subjected to. By taking a forming tool currently in use and applying a sealing coating in accordance with the present invention, the vacuum integrity of the forming tool may be enhanced by providing what is in essence a new seal of the forming tool. Thus, any further breakdown of the surface(s) of the forming tool and the vacuum seal may be slowed or stopped.

In still another aspect, the present invention method may be applied to actually restore the vacuum integrity of a forming tool. It is common for forming tool to lose its vacuum integrity altogether, or at least enough so that the forming tool is incapable of creating and/or maintaining an adequate seal. Either way, when a forming tool is no longer able to create and/or maintain an adequate seal, the forming tool is no longer usable. Although lost, the present invention method may be used to restore the vacuum integrity of some forming tools. As applied, the sealing coating functions to form an airtight seal, and to repair the deterioration of the surface(s) of the forming tool. Thus, a forming tool previously slated to be discarded can be put back into production, with no need to replace the forming tool with a new one at that time.

No matter the condition of the forming tool, the present invention provides a method to enhance or repair the worn or damaged forming tool by applying a sealing coating to the forming tool. The determinant of how effective the sealing coating is will largely be based on the condition of the surface of the tool. Thus, in the event of a used forming tool, an inspection of the forming tool's surface may be required to determine the potential effectiveness of any applied sealing coating.

The exemplary method of FIG. 2 further comprises step 118, preparing a surface of the forming tool to receive the sealing coating and primer material. This step of preparing a surface of the forming tool may be an optional step. Indeed, it is contemplated that the present invention method may be used to enhance the vacuum integrity and extend the useful life of a forming tool without first requiring the preparation of the surface on which the sealing coating is to be applied. However, not first preparing the surface of the forming tool may render the sealing coating less effective and cause the sealing coating to have only limited success. On the other hand, properly preparing the surface of the forming tool to receive the sealing coating (and primer material) will improve the ability of the sealing coating to seal the porosity of the forming tool. Indeed, removing all oils, grit, dirt, loose particulates, old sealant, if any, and any other contaminants will contribute to the effectiveness of the sealing coating.

If it is determined in step 118 that such is required, then the actual step, step 122, of properly preparing the surface of the forming tool to receive the sealing coating may include any one or more of several acts commonly known in the art, such as those illustrated in step 122. For example, the step of preparing may comprise thoroughly cleaning the surface to remove all contaminants therefrom. There are several ways contemplated to clean the surface, many of which will depend upon the particular type of forming tool being used, the condition of the surface, etc. In one exemplary embodiment, the forming tool may be cleaned using the following process, namely first bathing the surface in a solvent, rinsing the solvent, bathing the surface in an alcohol, rinsing the alcohol, bathing the surface in ionized water, rinsing the ionized water, and then drying the surface. Of course, other cleaning methods are well known, and not described in detail herein. Suffice it to say that cleaning the surface prior to applying the sealing coating will increase the effectiveness of the sealing coating.

The step of preparing may further comprise grit and/or sandblasting the surface to facilitate the cleaning, as well as abrading the surface, each as commonly known and practiced in the art. Grit and/or sandblasting may help to remove difficult contaminants, such as any old sealing materials. Abrading the surface may help facilitate the bond of the sealing coating to the surface of the forming tool. An end surface finish may be between 200 RMS and 8 RMS for metallic surfaces, and 1500 RMS to 32 RMS relative for composite or non-metallic surfaces.

In still another embodiment, the step of preparing the surface may comprise using a chemically etching process or procedure, also as known in the art. The step of preparing may comprise any one act or a combination of acts.

Once the surface has been properly prepared, and is ready to receive the sealing coating, or if the step of preparing is not desired, the exemplary method shown in FIG. 2 further comprises step 126, optionally applying a primer material to the surface of the forming tool. The present invention contemplates the use of a primer material designed to be applied to the working or non-working side or surface of the forming tool prior to applying the sealing coating. The primer functions primarily to facilitate the bonding of the sealing coating to the surface of the forming tool so as to provide a more permanent seal that is not easily removed. In other words, the primer is designed to increase the bonding potential between the sealing coating and the surface of the forming tool. The ability of the primer to facilitate such bonding, and the particular type of bonding achieved, will largely depend upon the type of primer used. The primer may be applied directly to a non-prepared surface, or one that has been properly prepared, including cleaning, sand or grit blasting, chemically etching, and/or abrading, as necessary.

In one exemplary embodiment, the primer material may comprise an epoxy primer material, which has been discovered to interact or work well with urea and urethane compounds. One particular example of an epoxy primer is Dupont Metalok™-CVP, which is an epoxy pretreatment 250S having an activator 255S. The epoxy primer material, and others similar to this makeup, are based on epoxy resin chemistry. In the context of the present invention, it is contemplated that an epoxy primer material may be used, which will facilitate a greater bond of the sealing coating to the surface of the forming tool, thus sealing the forming tool. Using this particular primer material will function to facilitate a chemical type of bond known as chemabsorption, meaning that the bond is a result of the polar interactions between the sealing coating and the primer and the primer and sealing coating and the surface of the forming tool, and that little or no chemical reaction occurs between the primer and the sealing coating. Nonetheless, the epoxy primer and the created chemabsorption bond will provide a strong, airtight seal about the surface of the forming tool, as intended. Although sufficiently strong to provide an airtight seal for the purposes discussed herein, or in other words although the polar interactions are sufficient, because of the chemabsorption bond facilitated by the epoxy primer material, the sealing coating may be removed by applying a solvent, such as methyl ethyl ketone, or other similar compound that releases or destroys the bond. By releasing the bond, the sealing coating may be easily removed. This may be advantageous in certain conditions or instances, such as where several new sealing coatings are desired on the same forming tool over a specified period of time.

In another exemplary embodiment, the primer material may comprise an amine cured epoxy resin, which has also been discovered to interact or work well with urea and urethane compounds. With this particular primer material, a true chemical bond is created between the sealing coating, the primer material, and the surface of the forming tool. Stated differently, using an amine cured epoxy type of primer material, a chemical bond is created in which the primer material chemically reacts with the sealing coating to the point where cross linking is caused to occur within the sealing coating. As such, the resulting bond may be considered a chemical and a mechanical bond. The presence of the primer material causes the sealing coating to react and mix with the primer material, thus effectively joining these components together. Indeed, because of the chemical reaction that takes place and the resulting cross linking, the bond created between the sealing coating and the surface of the forming tool is very strong. Simply applying a solvent or other compound will not act to release the bond.

The primer material, although optional, functions to facilitate each of the above described chemical bonds as the sealing coating is intended to be applied after the primer material is received onto the surface of the forming tool, and before the primer material is allowed to dry or cure. In its uncured state, the primer material is capable of interacting with the sealing coating in one or more ways, whether such interaction facilitates polar interactions, or a more durable chemical reaction and resulting cross linking within the sealing material, as discussed above. Thus, as illustrated in FIG. 2 by decision step 130, the primer material is preferably not allowed to cure before the sealing coating is applied. If the primer material has been applied and has cured, either additional primer material should be applied, or the surface of the forming tool once again prepared as needed, and as shown in step 118 and discussed above, which may include removing the primer material initially applied and allowed to cure.

The bond achieved between the sealing coating and the surface of the forming tool should be configured to be as strong as possible as the sealing coating is not intended to be removed. The bond also should be configured to be strong as the coating tends to expand and contract during heat cycles and such movement promotes cracks and other imperfections in the sealing coating. Moreover, the bond should be configured to be particularly strong about the edges of the forming tool so the sealing coating does not separate from the surface of the forming tool and compromise the vacuum integrity of the sealing coating, and therefore the forming tool.

In the case of forming tools having a metallic surface to which the sealing coating is to be applied, and although not required, the step of preparing, step 122, may further comprise applying a metal preparation material (e.g., a conversion coating) to the surface to better prepare the metal surface prior to applying the primer material. The metal preparation material may function to better receive the primer material and ultimately the sealing coating, and to assist the primer material in adhering or bonding to the metal surface of the forming tool. As the primer material may be better received, this may help the primer material to facilitate a better bond of the sealing coating, as discussed above.

The exemplary method of FIG. 2 further comprises step 134, obtaining a sealing coating to be applied to a surface of the forming tool. The sealing coating is designed and configured to cover the surface of the forming tool, to stop leaks, and to provide an airtight seal about the surface, including any seams, joints, bolt or other fastener connections, etc., thus ensuring the vacuum integrity of the forming tool. Stated differently, the sealing coating functions to seal the porosity of the forming tool by sealing various leaks or leak paths within the forming tool caused by surface deteriorations, surface inconsistencies, seams, and/or coupling means (e.g., bolts). The sealing coating may be applied to a surface of the forming tool, and caused to penetrate into the cracks or pores or other imperfections to seal such imperfections. Once applied and cured or polymerized, the sealing coating will restore and/or enhance the vacuum seal or vacuum integrity of the forming tool, thus extending the tool's useful life, or in other words, thus rendering the tool operable and usable for additional processing cycles beyond the number of cycles the tool may have otherwise performed.

The sealing coating is intended to bond with the surface of the tool in one or more ways. The particular bond achieved will depend upon various factors, such as the quality of the surface being bonded to, the formulation of the primer material, the formulation of the sealing coating, and the curing conditions. The bond may be a chemical bond, a chemabsorption bond, and/or a mechanical bond. Essentially, the bond functions to cause the sealing coating to interact in one or more ways with the surface of the forming tool to achieve an airtight seal and to restore and/or extend the vacuum integrity of the forming tool. As indicated above, it is contemplated that the bond of the sealing coating may be facilitated by the primer material as the primer may be configured to comprise a specific formulation that contributes to the type of bonding of the sealing coating, namely in its uncured state.

In one exemplary embodiment of the present invention, the sealing coating applied to the surface of the forming tool, over the uncured primer material, may comprise a resin, which resin may be applied in one or more layers. The resin may be a thermosetting resin having a substantially rapid cure time and high tensile strength. In one particular embodiment, the resin may comprise a liquid resin having a urea/urethane composition, or a polymerized polyurea/polyurethane composition. The thermosetting resin of urea and urethane is capable of withstanding typical autoclave temperatures of 350° F. That, and the rapid cure time, make the forming tool easy to test for leaks or leak paths immediately after the sealing coating is applied, and to concentrate an application of sealing coating to those areas where leaks persist.

In one exemplary embodiment, the urea (or polyurea) may be present within the sealing coating in an amount between 5 and 15 percent by weight, with the urethane (or polyurethane) present in an amount between 85 and 95 percent by weight.

The resin may also comprise a non-reactive composition, wherein a first component comprises an aromatic or aliphatic diisocyanate prepolymer compound; and a second component that comprises a chain extender and a mixture of compounds. The mixture of compounds can be selected from the group consisting of primary diamine, secondary diamine, hydroxyl terminated compounds and mixtures thereof. Various additives may also be incorporated into the resin composition, such as piezoelectric materials, metallic fibers, fiberglass fibers, etc. The particular application of the resin may depend on its formulation, including any additives.

In a more particular thermosetting resin, an exemplary formulation may include a first component and a second component, wherein the first component comprises an aromatic or aliphatic diisocyanate prepolymer compound, and the second component comprises a blend of primary or secondary diamine compounds and a chain extender. The diisocyanate prepolymer compound can be selected from 4,4-methylenediphenyl diisocyanate (MDI), 2,4-toluene diisocyante (TDI), hexamethylene diisocyanate (HDI), isophorone diisocyanate (IPDI), 4,4′-dicyclohexylmethane diisocyanate (HMDI) and mixtures thereof. Generally, the diisocyanate prepolymer compound is 4,4-methylenediphenyl diisocyanate and 2,4-MDI which has previously been partially polymerized with a polyol, (e.g. amine terminated or hydroxyl terminated prepolymer). The blend of primary or secondary diamine compounds of the second component are typically difunctional or trifunctional amine-terminated polyether compounds. In addition the chain extender may comprise a diethyl toluene diamine (DETDA) compound. Moreover, the thermosetting resin can be comprised of material that is inert or non-reactive. The percentages by weight of each component vary depending on the application. For example, in one embodiment the thermosetting resin composition may comprise the first component present in an amount of about 50%, and the second component present in an amount of about 50%.

The prepolymer composition may comprise any component or group of components which combine to form a coating that polymerizes (e.g., rapidly within seconds or minutes depending upon the composition) at ambient conditions, about the tool surface to which it is applied to form a semi-rigid, flexible member. In one exemplary embodiment, the prepolymer may comprise a polyurea-based composition made by combining an “A” side isocyanate component with a “B” side resin blend component, wherein these two components may be mixed and dispensed from a spray device. The isocyanate component may be further broken down into an isocyanate building block, such as an MDI monomer, connected to a flexible link with a urethane bond. In the preferred embodiment above, the isocyanate building block may have reactive end groups selected from a group consisting of polyol or amine, and the flexible link can be selected from a group consisting of polyether, silicone, polybutadiene or other low ‘Tg’ segments.

To enable rapid or other polymerization, the isocyanate component, or “A” side, is mixed with the resin blend, or “B” side component, which in one embodiment, as discussed above, comprises an amine-terminated polymer resin. When mixed together, the two A and B side components combine by way of a urea bond to form a long, polyurea-based molecule, which then cross-links with other similar molecules to form the semi-rigid, sealing member of the present invention.

The present invention contemplates many different types or variations of the prepolymer composition. For purposes of discussion, an exemplary first specific type of polyurea-based prepolymer composition comprises a two part polyurea, namely an “A” side polymeric MDI comprised of diphenylmethane-diisocyanate (MDI), and modified MDI; and a “B” side polymeric polyol comprised of aliphatic amines (polyoxypropylene diamine), di-ethyl toluene diamine (DETDA). The “A” side is present in an amount by weight between 25 and 40 percent, and preferably between 30 and 35 percent. The “B” side is present in an amount by weight between 60 and 75 percent, and preferably between 65 and 70 percent. This composition is available under the several products being marketed as Reactamine®, or as comprising Reactamine® technology.

An exemplary second specific type of polyurea-based prepolymer composition comprises a two part polyurea, namely an “A” side aromatic isocyanate comprised of polyurethane prepolymer, diphenylmethane-diisocyanate (MDI), and alkylene carbonate; and a “B” side aromatic polyurea comprised of polyoxyalkyleneamine, diethyltoluenediamine (DETDA), and polyoxyalkyleneamine carbon black. The “A” side is present in an amount by weight between 40 and 60 percent, and preferably between 45 and 55 percent. The “B” side is present in an amount by weight between 40 and 60 percent, and preferably between 45 and 55 percent. This composition is available from Bay Systems North America.

It is noted that these two compositions are not meant to be limiting in any way. Indeed, those skilled in the art may realize other compositions that may be used to provide a multi-function vacuum bag as taught and described herein.

Indeed, other types of sealing coatings contemplated for use include ureas made from isocyanate monomers, not prepolymers. Still other types of sealing coatings contemplated for use are silicones, namely sprayable silicones.

As shown in FIG. 2, the present invention further comprises step 138, applying the sealing coating to the surface of the forming tool, over the uncured primer material. The sealing coating is designed to be applied onto the external surface, preferably the non-working surface, of the forming tool, which surface may have cracks, fissures, pores imperfections, etc. therein. Forming tools often form leaks that leak air from the non-working or back side to the working side. However, it is also contemplated that the sealing coating may be applied onto the working surface of the forming tool, which also may have cracks, fissures, pores, or other imperfections therein. The sealing coating may be applied to the surface, with particular attention given to the various imperfections in the forming tool, if any, and if desired.

A sufficient amount of sealing coating should be applied to the forming tool in order to properly bond with the surface to enhance or restore the vacuum integrity of and to seal the forming tool. In one exemplary embodiment the sealing coating may be applied onto the surface at a thickness within a range of 1-5 mm, and preferably between 2-3 mm. In another embodiment the sealing coating may be applied at thickness greater than 5 mm. The thickness of the sealing coating may depend on a variety of factors, and may be determined on a case by case basis.

In one exemplary embodiment, the sealing coating, or the components thereof, may be pre-heated and applied between 70° and 200° F., and preferably between 100° and 160° F. In addition, the surface of the forming tool, prior to receiving the sealing coating, may be between 60° and 150° F., and preferably between 65° and 120° F. A surface temperature of 85° F., plus or minus ten degrees, has been found to provide a good range for applying the sealing coating and achieving an airtight seal.

As illustrated in steps 142 and 146 of FIG. 2, the sealing coating may be formulated or configured as a rapid-setting formulation so as to enable application via a dispensing method, such as spraying, or as a slow-setting formulation so as to enable application via a manual method, such as brushing. A rapid-setting formulation will allow dispensing through a sprayer or other dispenser to cover large surface areas. In addition, a rapid-setting formulation will allow the tool to be used shortly after application of the sealing coating (e.g., within five minutes). A slow-setting formulation, designed to be applied manually (e.g., with a brush), will allow application of the sealing coating to difficult to reach areas of the tool.

In the case of a slow-setting sealing coating, such as one that may be brushed onto the surface of the forming tool, the composition or formulation of the sealing coating may be modified so that its component parts are configured to react at a slower rate. One exemplary way to do this would include the use of an aliphatic isocyanate monomer in place of an aromatic isocyanate prepolymer. Aliphatic isocyanate reacts more slowly with amines. Another way to slow down the reaction may be to adjust the amount and type of catalyst present in the composition.

Step 138, applying the sealing coating may be accomplished or carried out using any application method and/or means known in the art. For example the sealing coating may be applied using one of a variety of spraying methods, which spraying methods may utilize one of a variety of spray systems or devices. Examples of spray systems or devices include, but are not limited to, compressed air, airless, aerosol and other known systems or devices. Preferably, however, the type of spraying method used is carried out using an airless spraying system or device. Using a spray on application method serves to promote even distribution or application of the sealing coating to the surface of the forming tool, such as in the case of a thermosetting sealing resin composition.

In the case of a sealing component comprising two or more components, a particular spraying device may be utilized that dispenses the sealing coating in a mixed state. In one aspect, the spraying device may be configured to mix the components of the sealing coating composition within the nozzle or other mixing chamber upon actuation of the sprayer. In this embodiment, the components of the sealing coating are stored in two or more tanks, with each tank being fluidly coupled to the spraying device. Once the spraying device is activated, at least some of the components are brought together and mixed within the mixing chamber of the spraying device, after which they are dispensed or discharged through the nozzle. In another similar aspect, the spraying device may be configured to cause the components to mix at the point of or shortly after discharge from the nozzle. In still another aspect, the sealing coating may be mixed prior to being communicated to the spraying device in a mixing chamber, which mixing chamber is also fluidly coupled to the spraying device. In this embodiment, the sealing coating formulation is communicated to the spraying device from the mixing chamber in an already mixed state.

Another application method that may be used for applying the sealing coating may include a manual application method, such as with a brush, squeegee, or other instrument or device. This application method will most likely be utilized with a slow-setting sealing coat, such as the one described above, to apply the sealing coating to hard to reach areas of the forming tool or areas needing additional attention, such as seams, cracks, and/or fasteners used to couple two or more components of the forming tool together.

Still another application method that may be used for applying the sealing coating may involve an automated application method. For example, various robotic or other automation systems may be utilized and configured to apply the sealing coating in accordance with associated or corresponding computer programs designed to control the robotic systems. Any automated applications may be supplemented with manual applications (e.g., spraying, brushing, etc.) where needed.

The exemplary method of FIG. 2 further illustrates step 150, curing the sealing coating to effectuate the bond of the sealing coating to the surface of the forming tool. The step of curing may comprise any method known in the art, and will largely depend upon the composition of the sealing coating, the composition of the primer, the level of preparation of the surface of the forming tool, and other factors known in the art. In many instances, the sealing coating may be configured to cure within seconds after application, thus allowing the forming tool to be used immediately. Indeed, a curing time for a thermosetting resin can be as little as 2-5 seconds depending on the resin formulation. A nominal curing time serves to promote a time reduction in the entire sealing process.

Depending upon the type of sealing coating and primer material used, the step of curing can include any known methods in the art, such as subjecting the forming tool and the sealing coating as applied thereto to radiation, changes in temperature, pressure, etc. In addition, the step of curing can be carried out for any suitable duration of time. Preferably, curing will be conducted for a pre-determined time, and at a pre-determined temperature and pressure using methods commonly known in the art.

FIG. 2 further illustrates step 154, wherein the method may be repeated as often as necessary to apply subsequent sealing coatings to the surface of the forming tool. The step of repeating to apply subsequent coatings may or may not include removing any existing coatings. If a subsequent coating is to be applied, the method will involve an inspection of the forming tool and include an analysis of whether or not to prepare the surface prior to applying the subsequent sealing coating(s), as illustrated by the arrow leading to step 118. Once the step of preparing is completed, if desired, the additional steps of applying a primer material (step 126), obtaining a sealing coating (step 134), and applying the sealing coating (step 138) are repeated to apply the subsequent sealing coating and to again enhance the vacuum integrity of the forming tool.

With reference to FIGS. 3 and 4, illustrated is a partial cut-away, cross-section of a forming tool in accordance with one exemplary embodiment. As shown, the forming tool 210 comprises a structural member 212 having a non-working surface 216 opposite a working surface 220 configured for use in forming a composite part. In the embodiment shown herein, the non-working surface 216 comprises a primer material layer 224 configured to receive a sealing coating.

The forming tool 210 further comprises a sealing coating 228 (see FIG. 3-A) deposited onto the non-working surface 216, over the primer material 224, wherein the sealing coating 228 is bonded to the non-working surface 216 as facilitated by the primer material 224. As indicated above, the sealing coating is configured to enhance the vacuum integrity and prolong the useful life of the forming tool. The bond of the sealing coating 228 to the non-working surface 216 functions to increase the durability of the sealing coating 228.

As will be recognized by those skilled in the art, the following examples are intended for illustration purposes only, and therefore, should not be construed as limiting in any way.

### EXAMPLE ONE

An example of the present invention method was performed, wherein a forming tool having exceeded its useful life was obtained. The forming tool had deteriorated to the point where its vacuum integrity was lost, and it no longer was able to provide or maintain an airtight seal. The forming tool was saddle shaped and about five feet long and three feet wide. The non-working side or surface of the forming tool was prepared by cleaning and chemical etching. Once properly prepared, an epoxy primer material (namely the primer material sold under the name Metalock) was manually brushed onto the non-working side of the forming tool. The primer material was allowed to partially cure for about one hour at room temperature. After one hour, and after the primer material was partially set, a sealing coating comprising a polyurea/polyurethane composition was methodically sprayed on the non-working side of the forming tool, over the primer material. The sealing coating comprised polyurea present in an amount of 10% by weight, and polyurethane present in an amount of 90% percent by weight. The sealing coating was applied using an airless gun at 160° F., with a spraying device that is commonly used to spray urethane foam insulation. Once the sealing coating was applied, it was allowed to cure, which curing took about five seconds. The forming tool was then tested with negative pressure and found to hold within acceptable limits. The forming tool is now being reintroduced into production.

### EXAMPLE TWO

An uncured amine epoxy resin blend was used as a primer to receive and effectuate a bond of a sealing coating to seal an aluminum forming tool. The primer comprised a mixture of resin, namely Hexion Epon 828 epoxy resin, and a curing agent or curative, namely Hexion Curing Agent W, at a ratio of 23.7 parts curing agent to 100 parts resin. This mixture was then applied to the non-working surface of the forming tool. Upon partially curing, a sealing coating was applied to the surface of the forming tool, over the primer material. The forming tool was then cured at 350° F. for two hours. After the two hour cure time, it was impossible to remove the sealing coating from the non-working surface.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for enhancing the vacuum integrity and extending the useful life of a mold-type forming tool operable with negative pressure, said method comprising:
preparing a surface of said tool to receive a sealing coating thereon;
obtaining a sealing coating having a formulation comprising a urea and polyurethane composition;
applying said sealing coating to said surface; and
curing said sealing coating to effectuate said bond between said sealing coating and said surface, and to seal said surface.

2. The method of claim 1, further comprising applying a primer material to said surface prior to said applying said sealing coating, said primer material functioning to increase the bonding potential between said sealing coating and said surface of said forming tool.

3. The method of claim 1, wherein said step of preparing comprises preparing a non-working surface of said tool to improve said seal of said surface of said forming tool.

4. The method of claim 1, wherein said step of preparing comprises cleaning said surface of said tool to remove all contaminants therefrom.

5. The method of claim 4, wherein said cleaning said surface comprises:
cleaning said surface to remove all contaminants therefrom;
bathing said surface in a solvent;
rinsing said solvent from said surface;
bathing said surface in an alcohol;
rinsing said alcohol from said surface;
bathing said surface in ionized water;
rinsing said ionized water from said surface; and
drying said surface.

6. The method of claim 1, wherein said step of preparing comprises grit and/or sandblasting said surface to facilitate said cleaning.

7. The method of claim 1, wherein said step of preparing comprises chemically etching said surface.

8. The method of claim 1, wherein said step of preparing comprises abrading said surface of said tool to achieve a suitable RMS.

9. The method of claim 1, further comprising:
preparing said surface of said tool to receive a subsequent sealing coating, upon said tool being at least partially used, including removing any existing sealing coatings;
applying a subsequent sealing coating to said surface; and
curing said subsequent coating to again effectuate a mechanical and chemical bond between said subsequent sealing coating and said surface, and to seal said surface.

10. The method of claim 1, further comprising repeating said steps of preparing, applying a sealing coating, and curing to effectuate a bond between said a subsequent sealing coating and said surface, and to seal said surface.

11. The method of claim 10, wherein said step of repeating does not require prior removal of a first sealing coating.

12. The method of claim 2, wherein said primer material comprises an epoxy primer material configured to facilitate polar interactions between said sealing coating, said primer material, and said surface, wherein said bond comprises a chemabsorption type of bond.

13. The method of claim 2, wherein said step primer material comprises a cured amine primer material configured to facilitate a chemical reaction between said sealing coating, said primer material, and said surface, said chemical reaction resulting in cross linking of said sealing coating and said surface, wherein said bond comprises a chemical and mechanical bond.

14. The method of claim 2, wherein said primer material comprises:
an uncured amine epoxy resin blend primer material; and
a curing agent, said primer material comprising a ratio of 23.7 parts said curing agent to 100 parts said uncured amine epoxy resin.

15. The method of claim 1, further comprising pre-heating said sealing coating to a temperature between 70° and 200° F. prior to applying said sealing coating.

16. The method of claim 1, further comprising bringing said surface of said forming tool to a temperature between 60 and 150° F. prior to applying said sealing coating.

17. The method of claim 1, wherein said sealing coating comprises a resin selected from the group consisting of a thermosetting resin, a polymeric resin, and a thermoplastic resin.

18. The method of claim 17, wherein said thermosetting resin is selected from the group consisting of a urea, a urethane, polymers thereof, derivatives thereof, solvates thereof, and combinations thereof.

19. The method of claim 18, wherein said thermosetting resin comprises, at least in part, urea and urethane components.

20. The method of claim 19, wherein said urea is present in an amount between 5 and 15 percent by weight; and said urethane is present in an amount between 85 and 95 by weight.

21. The method of claim 17, wherein said resin comprises:
a) a first component including an aromatic or aliphatic diisocyanate prepolymer compound; and
b) a second component including a chain extender and a mixture of compounds, said compounds selected from a group consisting of primary diamine, secondary diamine, hydroxyl terminated compounds and mixtures thereof.

22. The method of claim 21, wherein said diisocyanate prepolymer compound is selected from a group consisting of, 4,4-methylenediphenyl diisocyanate (MDI), 2,4-MDI, 2,4-toluene diisocyante (TDI), hexamethylene diisocyanate (HDI), isophorone diisocyanate (IPDI) and 4,4′-dicyclohexylmethane diisocyanate (HMDI).

23. The method of claim 22, wherein said diisocyanate prepolymer compound is 4,4-methylenediphenyl diisocyanate and 2,4-MDI.

24. The method of claim 22, wherein said diisocyanate prepolymer compound is partially polymerized with a polyol.

25. The method of claim 24, wherein said polyol is selected from an amine-terminated compound and a hydroxyl terminated compound.

26. The method of claim 21, wherein said primary and secondary diamine compounds are amine-terminated polyether compounds having at least a functionality of 2.

27. The method of claim 1, wherein said sealing coating comprises a rapid-setting formulation.

28. The method of claim 1, wherein said sealing coating comprises a slow-setting formulation to facilitate a methodical application of said sealing coating.

29. The method of claim 28, wherein said step of applying comprises brushing on said slow-curing sealing coating manually to access difficult to reach areas of said surface.

30. The method of claim 1 or 2, wherein said steps of applying said primer material and said sealing coating is carried out using an application method selected from the group of a spray on application method, a manual application method, an automated application method, and any combination of these.

31. The method of claim 1, wherein said step of curing comprises subjecting said forming tool, with its applied sealing coating, to a pre-determined temperature for a pre-determined duration of time.

32. The method of claim 31, wherein said pre-determined temperature ranges between 70° F. and 500° F.

33. The method of claim 2, wherein said primer material is configured to effectuate a bond of said sealing coating selected from a mechanical bond, a chemical bond, a chemabsorption bond, and a combination of these.

34. The method of claim 1 or 2, wherein said steps of applying a primer material, applying a sealing coating, and curing said sealing coating are carried out without the need for vacuum bagging said forming tool.

35. The method of claim 1, further comprising causing said sealing coating to polymerize or cross-link, thus increasing its strength about said surface of said forming tool.

36. A method for enhancing the vacuum integrity and extending the useful life of a mold-type forming tool operable with negative pressure, said method comprising:
applying a primer material to a surface of said forming tool;
obtaining a sealing coating having a formulation comprising;
applying said sealing coating to said surface, over said primer material, said primer material interacting with and facilitating a bond of said sealing coating to said surface; and
curing said sealing coating to effectuate said bond between said sealing coating and said surface, and to seal said surface.

37. A method for restoring the vacuum integrity of a used forming tool, said method comprising:
obtaining a forming tool having exceeded its useful life and having lost at least a portion of its vacuum integrity;
applying a primer material to a surface of said forming tool;
obtaining a sealing coating having a formulation;
applying said sealing coating to said surface, over said primer material, prior to said primer material drying, said primer material interacting with and facilitating a bond of said sealing coating to said surface; and
curing said sealing coating to effectuate said bond of said sealing coating to said surface, thus sealing said surface.

38. The method of claim 37, further comprising preparing a surface of said forming tool to receive said primer material and said sealing coating thereon.

39. A mold-type forming tool operable with a negative pressure, wherein said forming tool comprises a useful life determined by its ability to provide and maintain vacuum integrity, said mold-type forming tool comprising:
a working surface configured for use in forming a composite part;
a non-working surface opposite said working surface;
a primer material applied to said non-working surface in anticipation of receiving a sealing coating;
a sealing coating deposited on said non-working surface over said primer, before said primer is allowed to cure, said sealing coating being configured to enhance said vacuum integrity and prolong said useful life of said forming tool; and
a bond effectuated between said primer material, said sealing coating, and said surface of said forming tool, said bond being configured to increase the durability of said sealing coating.

40. The forming tool of claim 39, wherein said non-working surface is caused to be properly prepared prior to receiving said primer material and said sealing coating.

41. The method of claim 39, wherein said primer material comprises an epoxy primer material configured to facilitate polar interactions between said sealing coating, said primer material, and said surface, wherein said bond comprises a chemabsorption type of bond.

42. The method of claim 39, wherein said step primer material comprises an amine cured primer material configured to facilitate a chemical reaction between said sealing coating, said primer material, and said surface, said chemical reaction resulting in cross linking of said sealing coating and said surface, wherein said bond comprises a chemical and mechanical bond.

43. The method of claim 39, wherein said sealing coating comprises a resin selected from the group consisting of a thermosetting resin, a polymeric resin, and a thermoplastic resin.

44. The method of claim 43, wherein said thermosetting resin is selected from the group consisting of a urea, a urethane, polymers thereof, derivatives thereof, solvates thereof, and combinations thereof.

45. The method of claim 43, wherein said thermosetting resin comprise, at least in part, urea and urethane components.

46. The method of claim 45, wherein said urea is present in an amount between 5 and 15 percent by weight; and said urethane is present in an amount between 85 and 95 by weight.

47. The method of claim 43, wherein said resin comprises:
a) a first component including an aromatic or aliphatic diisocyanate prepolymer compound; and
b) a second component including a chain extender and a mixture of compounds, said compounds selected from a group consisting of primary diamine, secondary diamine, hydroxyl terminated compounds and mixtures thereof.

48. The method of claim 47, wherein said diisocyanate prepolymer compound is selected from a group consisting of, 4,4-methylenediphenyl diisocyanate (MDI), 2,4-MDI, 2,4-toluene diisocyante (TDI), hexamethylene diisocyanate (HDI), isophorone diisocyanate (IPDI) and 4,4′-dicyclohexylmethane diisocyanate (HMDI).

49. The method of claim 48, wherein said diisocyanate prepolymer compound is 4,4-methylenediphenyl diisocyanate and 2,4-MDI.

50. The method of claim 48, wherein said diisocyanate prepolymer compound is partially polymerized with a polyol.

51. The method of claim 50, wherein said polyol is selected from an amine-terminated compound and a hydroxyl terminated compound.

52. The method of claim 47, wherein said primary and secondary diamine compounds are amine-terminated polyether compounds having at least a functionality of 2.

53. The method of claim 39, wherein said sealing coating comprises a rapid-setting formulation.

54. The method of claim 39, wherein said sealing coating comprises a slow-setting formulation to facilitate a methodical application of said sealing coating.
